(19) United States
(12) Patent Application Publication
(10) Pub. No.: US 2015/0127382 A1
(43) Pub. Date: May 7, 2015

(54) SYSTEMS AND METHODS FOR IMPLEMENTATION OF A VIRTUAL EDUCATION HOSPITAL

(71) Applicant: NxTec Corporation, Mendon, MA (US)

(72) Inventors: Osama Al-Shaykh, Mendon, MA (US); Barbara Emond, Mendon, MA (US)

(21) Appl. No.: 14/532,538

(22) Filed: Nov. 4, 2014

Related U.S. Application Data
(60) Provisional application No. 61/899,539, filed on Nov. 4, 2013.

(51) Int. Cl. G06F 19/00; G06Q 50/20

(52) U.S. Cl. CPC G06F 19/322; G06Q 50/20
USPC 705/3

(57) ABSTRACT

A system for and method of facilitating collaboration among medical and healthcare professionals that includes presenting a request for initiating an electronic discussion via a communication network, enabling medical or healthcare professionals to participate in the discussion and to view medical record data germane to the discussion, depersonalizing the medical record data made available to the medical and healthcare professionals to remove any patient-identifying data, and categorizing and tagging discrete medical terms contained in the medical record data to enable association of the electronic medical discussion with an area of expertise of the medical or healthcare professionals.

### CROSS-REFERENCE TO RELATED APPLICATIONS

This application claims priority from U.S. Provisional Patent Application No. 61/899,539 filed Nov. 4, 2013, which is hereby incorporated by reference in its entirety.

### BACKGROUND OF THE INVENTION

The health industry is becoming fully digitized. One of the main elements of digitized health care is the advent of Electronic Medical Records (EMR), by which medical professionals electronically archive information about patients. Such information may include, for illustration and not limitation, personal information, allergies, medical tests, visit-logs, prescriptions, and so forth.

Medical professionals, e.g., physicians, nurses, dentists, surgeons, and the like, often typically consult with colleagues and peers about patient cases. For example, medical professionals may call each other, meet in rooms or collaborate to find the right diagnosis and medication. Such interactions occur via traditional communication methods, e.g., phone, fax or in person.

Medical professionals' practices, however, are also governed by heightened moral and ethical codes. Such codes are typically legislated through privacy laws and medical ethics codes, which often impact the way and the extent to which medical professionals communicate, discuss, and/or share patient information. As a result, modern digital social media techniques, which are used to discuss and share information, e.g., social media functions provided by Facebook, Quora, Twitter, LinkedIn, and the like, cannot be used in a healthcare system. Indeed, such social media functions are designed for a completely different purpose, i.e., they are designed to leverage and exploit information about an individual, inter alia, to generate revenue. Consequently, such techniques cannot be used in digital health care systems and need to be rethought and redesigned before their features can be introduced into a health care system.

Notwithstanding, there are examples of systems and networks that have been introduced into the medical professional community. However, these applications are not fully integrated into and do not take advantage of the digital health care system. For example, Doximity from Doximity, Inc. of San Mateo, Calif. provides a medical network through which medical professionals may interconnect with other medical or healthcare professionals. Although Doximity lists and encourages medical and other healthcare professionals to discuss topics and to collaborate anonymously on patient treatment, it is a closed system, requiring enrolment and verification of every medical professional. Advantageously, Doximity and other like systems and networks provide medical and healthcare professionals with a secure communications platform to exchange information.

Some systems, e.g., Sermo(R) by WorldOne/Sermo of Boston, Mass., provides physicians with a vehicle to post and answer questions among the medical community. While others, e.g., HealthTap from HealthTap of Palo Alto, Calif., enable a patient or individual to post a healthcare question in order to solilcit advice or a recommendation from a medical and healthcare professional. Disadvantageoulsy, the latter do not necessarily adhere to the strict medical confidentiality code. The existing systems remain limited because they do not integrate basic medical or healthcare professional behavior and the medical system into their services.

### BRIEF SUMMARY OF THE INVENTION

The systems and methods described herein improve existing electronic healthcare systems by including and integrating innovative social media techniques with existing digital health systems, including electronic medical records, while adhering to the medical confidentiality code. Moreover, the process includes digital health care functionalities that improve privacy and security and allow for more collaboration among medical and healthcare professionals and more engagement by the patient.

This new approach integrates social media techniques and expert-crowd-sourcing with medical records to efficiently solicit opinions and to foster discussions for educational purposes. The secure systems protect the privacy and personal information of patients, while enabling medical and healthcare professionals to provide improved service to their patients, especially in rural and impoverished areas. For example, specialists can aid local family medical and healthcare professionals to provide better care for their patients. Moreover, medical students and medical professionals can learn from the diverse cases from all over the world.

A first aspect of the present invention provides a virtual education hospital system to facilitate collaboration between medical and healthcare professionals via a communication network while protecting a patient's identity. In some embodiments, the system includes a processing device that is structured and arranged to provide an electronic discussion among medical and healthcare professionals via the communication network, a digital hospital database containing data that are provided to the medical and healthcare professionals while participating in the electronic medical discussion, a depersonalization system for removing personally identifiable information from the data provided to the medical and healthcare professionals to prevent identification of the patient; and a medical tagging device for classifying data according to selected medical terms contained in the data. In some implementations, the system further includes a medical research center database, which is accessible via the communication network. In some variations, the medical research center database includes data from medical trials, articles from published medical journals, unpublished medical articles, case reports, and/or medical news reports. In some implementations, the system further includes a medical library database, which is accessible via the communication network. In some variations, the medical library database includes data from a disease database, a medical conditions database, a medical test database, and/or a medical substance database. In still another implementation, the system includes a paging center for paging medical and healthcare professionals, to request they participate in the medical discussion.

In some variations, the digital hospital database includes data from patient records, medical cases, files of the medical professional, and/or files of the healthcare professional.

Optionally, the system may further include a user interface that is configured to enable a requester of the request for a medical discussion to control what portion of a patient's medical records data is transmitted to the electronic discussion and/or a user interface that is configured to enable a requester of the request for a medical discussion to control what portion of comments made in electronic discussion is transmitted to the a patient's medical records data.

In a second aspect, a method of facilitating collaboration among medical and healthcare professionals using a system described above includes presenting a request for initiating an electronic discussion via the communication network, enabling medical or healthcare professionals to participate in the discussion and to view medical record data germane to the discussion, depersonalizing the medical record data made available to the medical and healthcare professionals to remove any patient-identifying data, and categorizing and tagging discrete medical terms contained in the medical record data to enable association of the electronic medical discussion with an area of expertise of the medical or healthcare professionals.

In some implementations, enabling a medical or healthcare professional to participate in the medical discussion includes verifying that a potential participant is a medical or healthcare professional. In some variations, the method further includes enabling a requester of the request for a medical discussion to control what data are made available to participants in the electronic discussion; enabling a requester of the request for a medical discussion to terminate the medical discussion, include some portion of the medical discussion in a patient's medical records data, and/or include some portion of the medical discussion in a publication; and prioritizing medical tags of medical terms according to their importance in the medical record data. In some variations of the latter, prioritizing includes assigning a priority based on a location of the medical tag within the medical record data and/or prioritizing includes assigning a priority based on a relevance of the medical tag with respect to the medical record data.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows an illustrative embodiment of a virtual educational hospital in accordance with the present invention;

FIG. 2 shows a flow shaft of an illustrative embodiments of a method of facilitating collaboration among medical and healthcare professionals via a communication network while protecting a patient's identity in accordance with the present invention; and

FIG. 3 shows a diagram depicting a depersonalization step in accordance with some embodiments of the present invention;

### DETAILED DESCRIPTION OF THE INVENTION

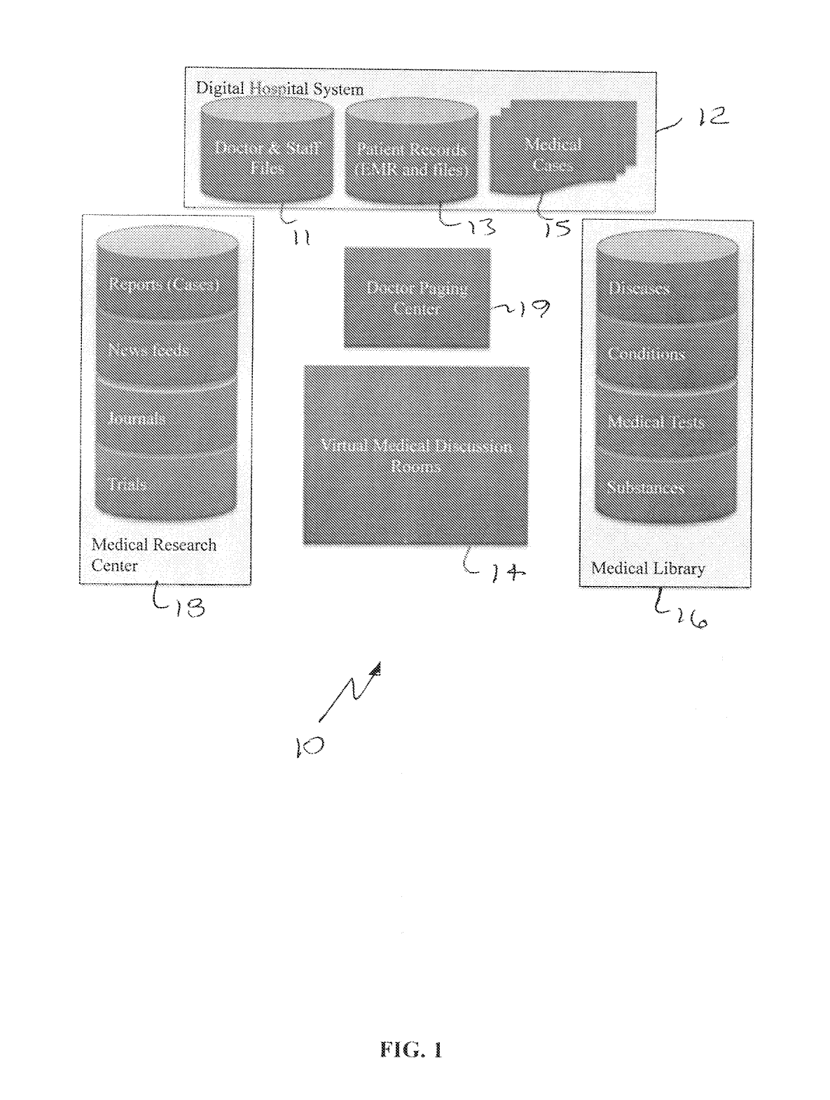

In a first aspect, referring to FIG. 1, the present invention includes a virtual education hospital (the system 10) that provides similar constructs of other medical and healthcare professional social networks while maintaining the integrity of information and privacy of the patients and professionals. In some embodiments, the system 10 comprises an Electronic Medical Record (EMR) system (e.g., a digital hospital system 12), a virtual medical discussion (“electronic discussion”) room 14, and a library 16, all of which are integrated with each other. In some implementations, the digital hospital system 12 may include, for the purpose of illustration and not limitation, medical and healthcare professional and medical staff files, profiles, and groupings 11, patient medical records files 13, and data of any special medical cases 15.

In some implementations, the virtual, medical discussion (“electronic discussion”) rooms 14 include for a for individuals or groups to collaborate or consult with other medical or healthcare professionals via a communication network. The groups may be organized or non-organized, e.g., medical students or interns may study cases in a group organized by faculty, or may participate in ad hoc discussions with other medical professionals regarding specific cases or new research. In some variations, electronic discussion rooms 14 are linked to patient records 13 via the digital hospital system 12. In some variations, patient information is linked to the patient medical record 13 via a depersonalization component, discussed in greater detail below. Advantageously, electronic discussion rooms 14 include one or more of the following features. The electronic discussion rooms 14, as well as the entire system 10, are generally not open to the public but are open only to medical and healthcare professionals and access is controlled using authentication credentials and/or invitations from existing users. Electronic discussions rooms 14 are associated with a patient (anonymous or real), and the description of the discussion topic is “owned” by one or more individuals—typically the person(s) who initiated the discussion. The owner(s) of each discussion rom are the only person(s) that can edit, close or publish the results of the medical discussion.

Typical patient data use scenarios may include patient pre-existing conditions automatically made available to discussion room participants. Family, biological, and genetic history and information may also be automatically made available to discussion room participants. Tests on the patients and test results as well as the patient's prescriptions may be automatically made available to discussion room participants. The owner of the case associated with a discussion room also may share comments and components of the electronic medical record 13 with the discussion room participants. The owner can choose to share all available information or may selectively share some information based on the data, the individual users, or a combination of the two, such that certain information is shared with some participants, and not others.

A patient (as well as the patient's health proxy designee) may opt out and remove (or decline to make) their files available for teaching or research. In such cases, the system follows the patient's decision as well as the decisions of family, biological family members, and the patient's health proxy instructions. This can be accomplished, for example, using a patient-only application and user interface, whereby users manage their own information and learn more about their own health.

Shared information from the patient's records 13 provided to the electronic discussion room 14 can be updated periodically and automatically in either the electronic discussion room 14 or in the digital hospital system 12, with a further ability to automatically update data at the other location. The patient's primary medical or healthcare caretaker can select specific information from the patient medical record 13 for import into the electronic discussion room 14. In instances in which the data includes names, or other personal information, the information is depersonalized. The medical professional can copy updated or modified information from the electronic discussion room 14 to the patient's electronic medical record 13. This may include, for example, medical tests to be requested, comments to educate the patient about her condition, general comments and/or diagnoses. Indeed, information transmitted back to the patient's medical records 13 can include all or some portion of the entire discussion in the electronic discussion room 14. This discussion can be made available to the patient, in whole or in part, to provide her with more information of her condition and diagnosis or, in some cases, it can be selectively hidden from the patient, to reduce anxiety.

In some implementations, the medical library 16 may include a compilation of medical and biological sciences text, scientific books, and material which the users may refer to and use as reference materials while participating in the discussions.

In some variations, the system 10 may also include a Medical Research Center 18, wherein medical professionals can conduct medical trials, publish new findings and the results of research, and receive the latest information for medical field and biology sciences, e.g., from professional journals, news feeds, and so forth.

In some variations, the system 10 may further include a paging system 19 that is configured to contact medical and healthcare professionals for immediate patient needs or for assisting other medical staff to diagnose or conclude a case. For example, a requester may know of a particular medical or healthcare professional who is a specialist in a certain field of medicine or surgery germane to the requester's case. As a result, the system may enable the requester to page, e.g., by email, by text message, by telephone call, and so forth, the specialist.

Preferably, system users may practice using any computer system configuration, including hand-held wireless devices such as mobile or cellular telephones, personal digital assistants (PDAs), tablet computers, smartphones, smartpads, smartwatches, Google® glasses, tablet computers, laptop computers, personal computers, gaming systems, multiprocessor systems, microprocessor-based or programmable consumer electronics, minicomputers, mainframe computers, computers running under virtualization, and/or any other computing device that is capable of capturing audio and/or video data.

The data store may be embodied using any computer data store, including but not limited to relational databases, non-relational databases (NoSQL, etc.), flat files, in memory databases, and/or key value stores. Examples of such data stores include the MySQL Database Server or ORACLE Database Server offered by ORACLE Corp. of Redwood Shores, Calif., the PostgreSQL Database Server by the PostgreSQL Global Development Group of Berkeley, Calif., the DB2 Database Server offered by IBM, Mongo DB, Cassandra, and Redis.

The invention may be practiced using any computer or processing system 10 that may include a general purpose computing or processing device, i.e., client device, including a processing unit, a system memory, a data storage medium, and a system bus that couples various system components including the system memory to the processing unit.

Client devices typically include a variety of computer readable media that can form part of the system memory and be read by the processing unit. By way of example, and not limitation, computer readable media may include computer storage media and/or communication media. The system memory may include computer storage media in the form of volatile and/or nonvolatile memory, such as read only memory (ROM) and random access memory (RAM). A basic input/output system (BIOS), containing the basic routines that help to transfer information between components, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Mac OS operating system, Google Android operating system, Apple iOS operating system, or another operating system or platform.

At a minimum, the memory may include at least one set of instructions that is either permanently (non-volatile) or temporarily (volatile) stored. The processing unit executes the instructions that are stored in order to process data. The set of instructions may include various instructions that perform a particular task or tasks. Such a set of instructions for performing a particular task may be characterized as a program, software program, software, engine, module, component, mechanism, or tool.

The client device may include a plurality of software processing modules stored in the memory as described above and executed on the processing unit in the manner described herein. The program modules may be in the form of any suitable programming language, which is converted to machine language or object code to allow the processor or processing units to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Basic, C, C++, CSS, HTML, Java, SQL, Perl, Python, Ruby and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

A user may enter commands and information into the client device through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, Storage Area Networking devices, solid state drives, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

One or more monitors or display devices may also be connected to the system bus, e.g., via an interface. In addition to display devices, the client device may also include other peripheral output devices, which may be connected through an output peripheral interface. The client device implementing the invention may operate in a networked environment using logical connections to one or more remote computers. The remote computers typically including many or all of the elements described above.

It should be appreciated that the processing units and/or memories need not be physically in the same location. For example, in some implementations, the system 10 may also include a general purpose computing or processing device, i.e., server device, including a processing unit, a system memory, a data storage medium, and a system bus. Hence, each of the processing units and each of the memories used by the system 10 may be in geographically distinct locations and be connected so as to communicate with each other in any suitable manner. Additionally, it is appreciated that each of the processing units and/or memories may be composed of different physical pieces of equipment.

The devices that embody the invention may communicate with the user via notifications sent over any protocol that can be transmitted over a packet-switched network or telecommunications (“communication”) network. By way of example, and not limitation, these may include SMS messages, email (SMTP) messages, instant messages (GChat, AIM, Jabber, etc.), social platform messages (Facebook posts and messages, Twitter direct messages, tweets, retweets, etc.), and mobile push notifications (iOS, Android).

It is understood that the methods and systems 10 described may contain software, middleware, hardware, and any combination thereof connected to, coupled with, and/or in communication with a communication network, e.g., the World Wide Web, the Internet, a local area network (LAN), a wide area network (WAN), and so forth. Computing/processing devices are capable of communicating with each other via the communication network, and it should be appreciated that the various functionalities of the components may be implemented on any number of devices.

The invention may be practiced using any communications network capable of transmitting Internet protocols. A communications network generally connects a client device with a server device, and in the case of peer-to-peer communications, connects two peers. The communication may take place via any media such as standard telephone lines, LAN or WAN links (e.g., T1, T3, 56 kb, X.25), broadband connections (ISDN, Frame Relay, ATM), wireless links (802.11, Bluetooth, 3G, CDMA, etc.), and so on. The communications network may take any form, including but not limited to LAN, WAN, wireless (WiFi, WiMAX), or near field (RFID, Bluetooth). The communications network may use any underlying protocols that can transmit Internet protocols, including but not limited to Ethernet, ATM, VPNs (PPPoE, L2TP, etc.), and encryption (SSL, IPSec, etc.).

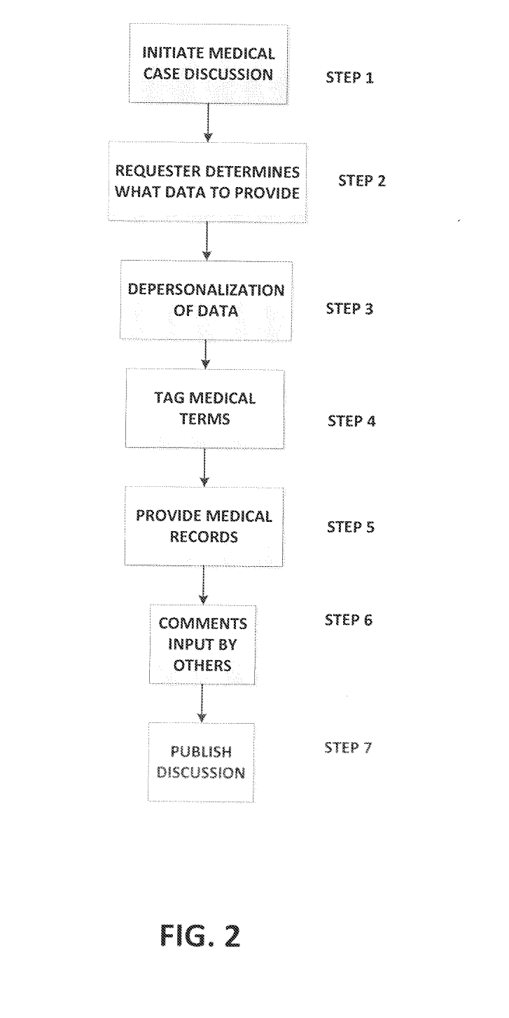

Further description of the system 10 and its various elements will be by way of an example of its operation, which is to say, a method of facilitating collaboration among medical and healthcare professionals via a communication network while protecting a patient's identity. Referring to FIG. 2, in an illustrative example of its use, a system (or platform) user (i.e., a “requester”) may initiate, i.e., request, an electronic, medical case discussion with other users of the platform (STEP 1). Typically, when a medical discussion is requested, all related conditions, including but not limited to the requester's medical diagnosis, may be attached to the discussion request to enable other registered and verified medical and healthcare professionals in the system 10 to add value to the medical diagnosis. This allows medical and healthcare professionals to have a more holistic view of the case.

For example, a request for an electronic, medical case discussion (STEP 1) to the medical community may originate directly from the electronic medical record (EMR) using, for example, a user interface that is operably connected to a processing device that is adapted to communicate with other processing devices via a communication network. Typically, requesters are medical or healthcare professionals who are treating a patient for whom advice or counsel from other medical or healthcare professionals, especially specialists, is desirable. In some implementations, the “medical community” may consist of other medical and healthcare professionals who have pre-registered with the system 10, which is, further, adapted to verify the identity and credentials of each medical and healthcare professional requesting registration. Once the system 10 has verified the credentials and identity of a medical and healthcare professional, the medical and healthcare professional may be provided with a user name and passcode to facilitate entering an electronic, medical case discussion.

Advantageously, once a case discussion is started (STEP 1), patient records, e.g., EMR, may be transmitted and made available (STEP 5), e.g., to an “electronic discussion” room 14. In some variations, the system 10 enables the requester to determine what medical information is to be provided and made available to others who have been allowed to enter the “electronic discussion” room 14 (STEP 2). Manual tools, e.g., a user interface, may be provided to medical and healthcare professionals as part of sharing the medical record. For example, in sharing a patient's medical record, the system 10 may enable the requesting medical and healthcare professional to edit medical tests further, to remove any embedded personal information in images or documents.

However, before these data are made available (STEP 5) to the “electronic discussion” room 14, the data are subject to a process referred to as depersonalization (STEP 3), through which all personal information about the patient is removed and only information relevant to the case and that cannot identify the patient, is made available to and used in the discussion communications. Depersonalization (STEP 3) is an integral part of the system 10. A goal of depersonalization (STEP 3) is the removal of any information that can lead to identifying the patient and its replacement with generic information. For example, all shared information may be automatically stripped of all fundamental personal information or information that can identify the person directly. Such information is “fixed” information, which is information that cannot change rapidly and is easily attributable to the person. This may include: first name, last name, personal identification numbers (e.g., social security number, driver's license number), credit card numbers, address, healthcare information, detailed job titles, name(s) of relatives, and other identifying information. For example, the system 10 may maintain family relationships and corresponding information, which is valuable to medical and healthcare professionals; however, the information when made available, is, as a rule, vague and non-identifiable as to the identity of the patient or her relatives. For example, a patient name can be replaced with “Joe_1 Doe_1”. His brother is Joe_2 Doe_1. A non-related person is Joe_1 Doe_2 and so forth.

The system 10 is also made sensitive so that information shared in the aggregate cannot (as a whole) be used to identify the patient indirectly. This classification of information is termed “accidental information,” which, typically, may include any incidental information that can lead to knowing or narrowing the identity of the person. For example, the combination of locale information, demographic information, and family history might (with some investigative skill or deduction) enable a third party to make a positive identification. For example, if the patient were in a car accident, the system 10 may be adapted to detect the date of the accident and any related terms (e.g., killed, number and identification of people in a car, etc.). Accordingly, the system 10 in this case may also be configured to identify the text containing the accident date and location or address and to remove it. Additionally, the system 10 may be adapted to make dates “relative,” to help medical and healthcare professionals know of the timing of certain events without knowing the exact calendar dates, which are not relevant to the case. For example, the system 10 can measure time from an important date in the patient's treatment or medical care, e.g., date of a significant diagnosis, date of hospital or ER admittance, and so forth. As a result, the actual dates are confidentially maintained while the “electronic discussion” dates are detailed relatively, e.g., “day 3 of treatment,” “day 7 after the head trauma,” etc. Another possibility, especially for wider date ranges or for use when events are not necessarily centered about a single accident or treatment plan, is to restate dates in terms of the age of the patient, e.g. in years/months old.

Depersonalization (STEP 3) operates on different parts of the discussion. Exemplary depersonalization operations or functions may include inclusion of family history without information leading to identifying the persons; inclusion of genetic information without information leading to identifying the persons; inclusion of biological relative information without information leading to identifying the persons; inclusion of medical test information without information leading to identifying the persons; inclusion of pre-existing conditions without information leading to identifying the persons; inclusion of comments from the medical record without information leading to identifying the persons; inclusion of demographic information without information leading to identifying the persons; inclusion of information about living conditions and locale information without information leading to identifying the persons.

Depersonalization (STEP 3) is also important for the educational hospital concept because it allows medical and healthcare professionals from different geographic locales to discuss and study the cases and provide opinions while protecting the privacy of the patient. Moreover, it is critical for any publication for such cases. Depersonalization (STEP 3) may also translate governmental, ethical, and organizational requirements, which can all be done using a depersonalization system, e.g., a depersonalizer, discussed in greater detail below. For example, certain countries may permit publication of more detailed geographical or demographic information than others or certain medical board organizations may have promulgated stricter privacy policies.

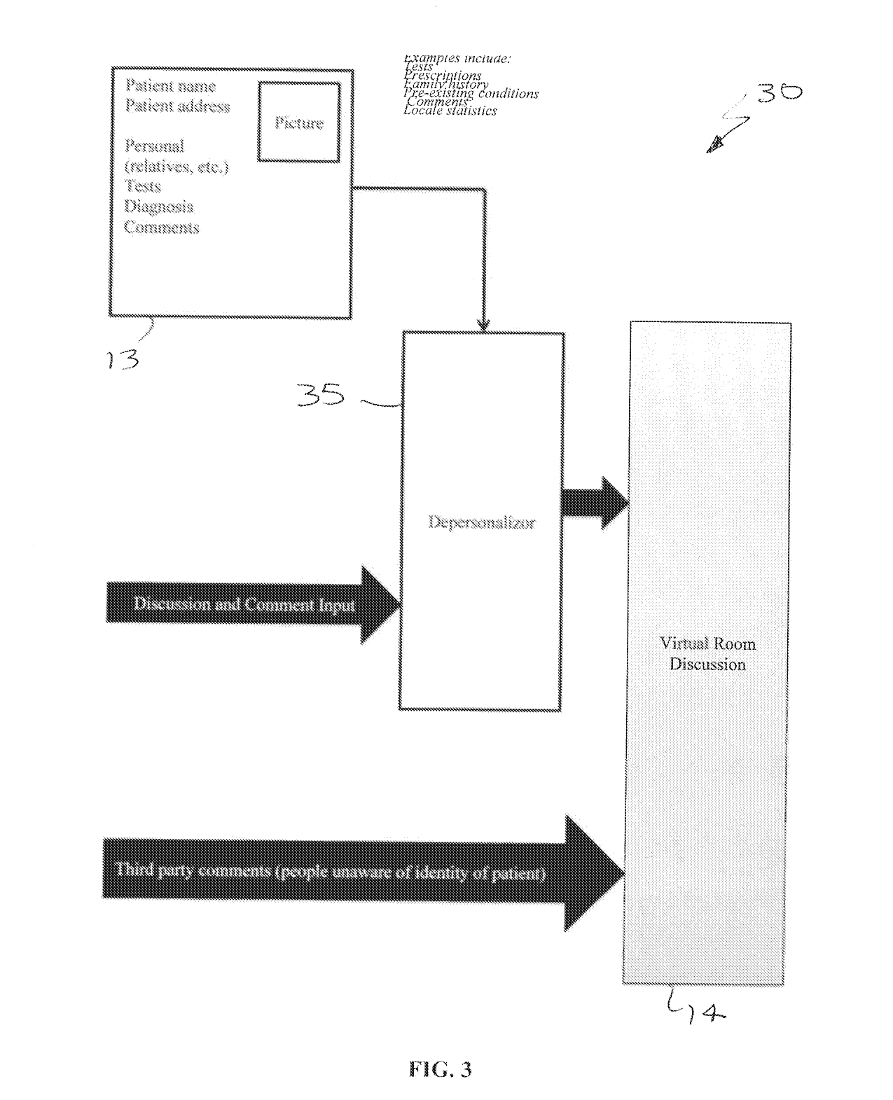

FIG. 3 shows an illustrative diagram depicting the depersonalization process 30 (STEP 3). At the core of depersonalization is a depersonalization device 35 that is advantageously disposed between and in communication, e.g., via a communication network, with medical records and other personal patient data 32 and the “electronic discussion” room 14. Although the requester provides a first level of review, to determine what information may be transmitted to the “electronic discussion” room 14, the depersonalization device 35 provides a second level of scrutiny and security, to ensure that information that can be used, directly or indirectly, to identify the patient, is removed before the data are released to the “electronic discussion” room 14.

Also, before the data are provided to the “electronic discussion” room 14 (STEP 5), the system 10 is adapted to tag certain medical data and terms to associate the data and terms with the medical tag (STEP 4). Hence, in some implementations tags can include refer to medical terms that are detected in medical communications, including reports, transcripts or notes of “electronic discussion” room 14 discussions, and electronic medical records 13. These terms may include medical conditions, illnesses, medical tests, and prescriptions. As a result, detecting and categorizing medical tags (STEP 4) are important parts of any virtual medical educational and teaching hospital in order to provide more information from medical textbooks, for cataloging cases, for recommending cases for individuals, and for medical and healthcare professionals to find medical discussion requests in their specialty area(s).

In some embodiments, tagging may include one or more of the following features. First, it may hierarchically link all medical terms to reduce the data used for categorization. Examples include removing any medical tag if the system 10 has already detected a medical term that has a high correlation to the new tag term. For example, there is no need to include “high temperature” as a symptom if “fever” is already detected. The system 10 also may weigh the frequency of occurrence of certain terms/medical tags in the text. Moreover, the system 10 may prioritize some medical tags based on their relative location within the text in which they appear. For example, higher importance may be attributed to medical terms that are included in a “electronic discussion” room definition title, an abstract or a summary. Any new updates about a patient's condition or diagnosis would have higher importance than a passing phrase in a comment.

Once detected and classified, medical tags may then be used (STEP 4), e.g., using a classification algorithm, which identifies the specialties and fields needed to discuss a case(s) or topic(s) to identify the “electronic discussion” room 14. Hence, medical tags and “electronic discussion” rooms 14 are important for discussing cases for better diagnoses, researching new technologies and medications, and as discussion topic for medical students based on previous or similar cases.

A complete medical tag system focuses on medical case sharing and discussion. For example, all cases and summaries posted to the “electronic discussion” room 14 may be searched for medical terms including prescriptions, tests, conditions, illnesses, and other high level “medical tags.” Medical tags may be supplemented with on-demand educational information to help the discussion. Medical tags are detected and categorized based on their importance in the medical record and “electronic discussion” room discussion. The importance of the tag changes based on its location and relevancy to the data in the whole case. For example, medical tags that are part of the subject-line or the summary of an “electronic discussion” room 14 are considered to be more important than other medical terms detected. Pre-existing conditions are very important medical tags. Medical terms that are already considered highly correlated with already detected medical tags will have lower weight and in some cases may be eliminated as medical tags. Tests and prescriptions are important and their relation with the illnesses and conditions already detected are highlighted in medical tag presentation. In some variations, medical tags that are classified as more important to the case to be discussed, may be highlighted, e.g., by the requester using a user interface, compared to less important medical tags. For example, “important” medical tags may be shown in a brighter color, in a larger or bolder font, and/or surrounded by a thicker graphic border compared to the less important medical tags.

Optionally, the “electronic discussion” room 14 may be automatically labeled with the specialties, e.g., hospital departments, needed to participate in the discussion. During the discussion, the tagging system continues working to provide the same functionality. Moreover, if the discussion included new terms, i.e., new medical tags that suggest new specialties, the system 10 may be adapted to notify the requesting medical and healthcare professional and may automatically invite new specialists into the discussion accordingly. Alternatively, the system 10 may recommend appropriate specialists to the requesting medical and healthcare professional who may then select or approve specialists for invitation into the discussion. Medical and healthcare professionals can edit the specialties and tags generated to provide more accurate analysis.

In some implementations, the system 10 may include a hybrid automatic/manual decision process. The requester may manually decide to edit the automatic selections if she chooses to. For example, the requester can delete, add or change the spelling of one of those terms that identify the case. This is beneficial because there may be more data that the responding medical or healthcare professionals will be sharing in the future or simply a human with her expertise can link things better.

Any new diagnosis of the patient or new conditions in the patient's EMR 13 may be automatically updated to the medical case discussion. This helps medical and healthcare professionals to follow the case more closely and, moreover, to experience real-time learning.

Once the “electronic discussion” room 14 has been set, the topic of the discussion made clear, and some portion of the patient's medical records made available to the “electronic discussion” room 14, medical and healthcare professionals who have entered the “electronic discussion” room 14 may comment on the case (STEP 6) as a whole or in part, e.g., individual events in the case. For example, a user interface may be used to present the case discussion details segmented into events such as consultations, test results, and treatment plans. The requesting medical and healthcare professional or any of the consulting medical and healthcare professionals may add a general comment to the overall discussion, or may select one of the displayed events in order to add a comment directed specifically to that event. The event comments may be interleaved in the case with the option to hide or display all the comments. Likewise, the user interface may allow a medical or healthcare professional or other user to hide or expand the detailed display of each individual event.

At some point in the discussion, the requester may close or terminate the medical discussion. When a case is closed it can be published for other medical and healthcare professionals and students to learn from. The published case is automatically generated with the option for the requesting medical and healthcare professional of the case to add conclusions and summaries, e.g., via manual insertion.

In some variations, at the requester's direction, a discussion case can kept private between the requesting medical and healthcare professional and one or more invited, consulting medical or healthcare professional/specialist until the requester closes the discussion case. Once a discussion case is closed, it is ‘published’ by the system 10 (STEP 7) and made available in depersonalized form for all to see and learn. The discussion case can also be part of a public discussion and in some instances published as a collaborative paper. In all forms, the privacy of the patient is protected and the medical ethical code is followed. Optionally, the published case may be archived for a pre-determined period of time or in perpetuity for use in future learning. For example, when a new discussion case starts, the nature of the discussion case and the medical tags may be used to explore if there are other cases in the system that are similar, to help medical and healthcare professionals in their discussion. These similar, archived cases may be presented of a display device associated with a user interface. The medical and healthcare professional or user may select a case(s) from the display, to access the details of the similar case and discussion. If cases are particularly relevant, a medical and healthcare professional/user may create a persistent link between the current case and a selected ‘related’ case.

Various embodiments and features of the present invention have been described in detail with particularity. The utilities thereof can be appreciated by those skilled in the art. It should be emphasized that the above-described embodiments of the present invention merely describe certain examples implementing the invention, including the best mode, in order to set forth a clear understanding of the principles of the invention. Numerous changes, variations, and modifications can be made to the embodiments described herein and the underlying concepts, without departing from the spirit and scope of the principles of the invention. All such variations and modifications are intended to be included within the scope of the present invention, as set forth herein. The scope of the present invention is to be defined by the claims, rather than limited by the forgoing description of various preferred and alternative embodiments. Accordingly, what is desired to be secured by Letters Patent is the invention as defined and differentiated in the claims, and all equivalents.

What we claim is:

1. A virtual education hospital system to facilitate collaboration between medical and healthcare professionals via a communication network while protecting a patient's identity, the system comprising:
a processing device that is structured and arranged to provide an electronic discussion among a plurality of medical and healthcare professionals via the communication network;
a digital hospital database containing data that are provided to the plurality of medical and healthcare professionals while participating in the electronic medical discussion;
a depersonalization system for removing personally identifiable information from the data provided to the plurality of medical and healthcare professionals to prevent identification of the patient; and
a medical tagging device for classifying data according to selected medical terms contained in the data.

2. The system of claim 1 further comprising a medical research center database, which is accessible via the communication network.

3. The system of claim 2, wherein the medical research center database includes data from at least one of medical trials, articles from published medical journals, unpublished medical articles, case reports; and medical news reports.

4. The system of claim 1 further comprising a medical library database, which is accessible via the communication network.

5. The system of claim 4, wherein the medical library database includes data from at least one of a disease database, a medical conditions database, a medical test database, and a medical substance database.

6. The system of claim 1 further comprising a paging center for paging medical and healthcare professionals, to request they participate in the medical discussion.

7. The system of claim 1, wherein the digital hospital database includes data from at least one of patient records, medical cases, files of the medical professional, and files of the healthcare professional.

8. The system of claim 1 further comprising a user interface that is configured to enable a requester of the request for a medical discussion to control what portion of a patient's medical records data is transmitted to the electronic discussion.

9. The system of claim 1 further comprising a user interface that is configured to enable a requester of the request for a medical discussion to control what portion of comments made in electronic discussion is transmitted to the a patient's medical records data.

10. A method of facilitating collaboration among medical and healthcare professionals via a communication network while protecting a patient's identity using a system that includes a processing device that is structured and arranged to provide an electronic discussion among a plurality of medical and healthcare professionals via the communication network; a digital hospital database containing data that are provided to the plurality of medical and healthcare professionals while participating in the electronic medical discussion; a depersonalization system for removing personally identifiable information from the data provided to the plurality of medical and healthcare professionals to prevent identification of the patient; and a medical tagging device for classifying data according to selected medical terms contained in the data, the method comprising:
presenting a request for initiating an electronic discussion via the communication network;
enabling a plurality of medical or healthcare professionals to participate in the discussion and to view medical record data germane to the discussion;
depersonalizing the medical record data made available to the medical and healthcare professionals to remove any patient-identifying data; and
categorizing and tagging discrete medical terms contained in the medical record data to enable association of the electronic medical discussion with an area of expertise of the medical or healthcare professionals.

11. The method of claim 10, wherein enabling at least one medical or healthcare professional to participate in the medical discussion includes verifying that a potential participant is a medical or healthcare professional.

12. The method of claim 10 further comprising enabling a requester of the request for a medical discussion to control what data are made available to participants in the electronic discussion.

13. The method of claim 10 further comprising enabling a requester of the request for a medical discussion to perform at least one of terminate the medical discussion, include some portion of the medical discussion in a patient's medical records data, and include some portion of the medical discussion in a publication.

14. The method of claim 10 further comprising prioritizing medical tags of medical terms according to their importance in the medical record data.

15. The method of claim 14, wherein prioritizing includes assigning a priority based on a location of the medical tag within the medical record data.

16. The method of claim 14, wherein prioritizing includes assigning a priority based on a relevance of the medical tag with respect to the medical record data.
